(19) United States
(12) Patent Application Publication
(10) Pub. No.: US 2026/0051724 A1
(43) Pub. Date: Feb. 19, 2026

(54) POWER BOX WITH ELECTRICAL PARAMETER ADJUSTING FUNCTION

(71) Applicant: Zhuhai Shengchang Electronics Co., Ltd., Zhuhai City (CN)

(72) Inventors: Chao HOU, Zhuhai City (CN); Jialong HU, Zhuhai City (CN); Dehua ZHENG, Zhuhai City (CN)

(21) Appl. No.: 18/828,111

(22) Filed: Sep. 9, 2024

(30) Foreign Application Priority Data
Aug. 19, 2024 (CN) 2024220170273

(51) Int. Cl. H02G 3/08

(52) U.S. Cl. CPC H02G 3/081

(57) ABSTRACT

Disclosed is a power box with an electrical parameter adjusting function, and particularly a power box with advantages of space saving and convenience in electrical parameter adjustment. The power box with an electrical parameter adjusting function includes a box body. A power supply chamber and wiring chambers are disposed in the box body, an inner cover plate and an outer cover plate are disposed on the box body, the inner cover plate covers the power supply chamber, the outer cover plate covers the power supply chamber and the wiring chambers, adjusting modules positioned in the power supply chamber are disposed on the inner cover plate, and adjusting holes corresponding to the adjusting modules are formed in the inner cover plate. The disclosure is applied to the technical field of a power junction box.

### TECHNICAL FIELD

The disclosure relates to the technical field of a power junction box, and particularly relates to a power box with an electrical parameter adjusting function.

### BACKGROUND

Some power junction boxes in the prior art may have some electrical parameter adjusting functions. However, their adjusting modules are disposed inside wiring chambers, spaces of the wiring chambers are occupied, and moreover, the adjustment by a user may be inconvenient due to small operation space during adjustment.

### SUMMARY

The disclosure aims at solving the technical problems to overcome the defects in the prior art and to provide a power box with advantages of space saving and convenience in electrical parameter adjustment.

The disclosure adopts the following technical solution: the power box with an electrical parameter adjusting function includes a box body. A power supply chamber and wiring chambers are disposed in the box body, an inner cover plate and an outer cover plate are disposed on the box body, the inner cover plate covers the power supply chamber, the outer cover plate covers the power supply chamber and the wiring chambers, adjusting modules positioned in the power supply chamber are disposed on the inner cover plate, and adjusting holes corresponding to the adjusting modules are formed in the inner cover plate.

Further, a middle partition board is disposed among the power supply chamber and the wiring chambers for partition, notches are formed on the middle partition board, the power supply chamber and the wiring chambers all communicate with the notches, a cable protection sheath is disposed on each of the notches, and cable passing holes are formed in the cable protection sheath.

Further, knocking-off holes are formed in each of the wiring chambers.

Further, a side plate is disposed at each of two sides of the box body, and installing holes are formed in the side plate.

Further, the quantity of the power supply chamber is at least one, the quantity of the wiring chambers is at least two, and the partition board(s) is(are) disposed among a plurality of wiring chambers for partition.

Further, a circuit board is placed in the power supply chamber, and the circuit board is electrically connected with the adjusting modules.

Further, a waterproof pad positioned in the box body is disposed on the outer cover plate.

Further, second rotary posts and a second clamping position are disposed on the box body, second rotary holes are formed in one end of the outer cover plate, the second rotary holes are rotationally connected with the second rotary posts, a second clamping clip is disposed at the other end of the outer cover plate, and the second clamping clip is able to be clamped and connected onto the second clamping position.

Further, the inner cover plate is connected onto the box body in one connection manner of threaded connection, rotational connection or clamping connection, and the outer cover plate is connected onto the box body in one connection manner of threaded connection, rotational connection or clamping connection.

Further, a first clamping position is disposed on the middle partition board, first rotary posts are disposed on the box body, first rotary holes are formed in one end of the inner cover plate, the first rotary holes and the first rotary posts are rotationally connected, the other end of the inner cover plate is provided with a first clamping clip, and the first clamping clip is able to be clamped and connected onto the first clamping position.

The disclosure has the following beneficial effects:

By aiming at the defects in the prior art, the disclosure adopts the solution that the adjusting modules are disposed on the inner cover plate and are positioned in the power supply chamber, so the occupation on the installation space of the wiring chambers may be avoided. When the adjusting module is adjusted, the influence by cables in the wiring chambers may be avoided. Additionally, during electrical parameter adjustment and after the outer cover plate is opened, the adjusting modules may be adjusted through the adjusting holes, so the electrical parameter adjustment is convenient, and the disclosure has the advantages of space saving and convenience in electrical parameter adjustment.

### BRIEF DESCRIPTION OF THE DRAWINGS

In order to describe the technical solution of embodiments of the disclosure or in the prior art more clearly, accompanying drawings to be used in embodiments or in the prior art are briefly introduced. Obviously, the accompanying drawings described hereafter are only some embodiments of the disclosure. For a person of ordinary skill in the art, other drawings can also be obtained according to these accompanying drawings without any inventive efforts.

FIG. 1 is a schematic diagram of a three-dimensional structure of the disclosure.

FIG. 2 is a schematic diagram of a plane structure of the disclosure.

FIG. 3 is a schematic exploded diagram of the disclosure.

### DETAILED DESCRIPTION OF THE EMBODIMENTS

The technical solution in embodiments of the disclosure will be clearly and completely described hereinafter with reference to the accompanying drawings in the embodiments of the disclosure. Obviously, the described embodiments are only a few, but not all, embodiments of the disclosure. Based on the embodiments in the disclosure, all other embodiments obtained by a person skilled in the art without any inventive efforts are all within the protection scope of the disclosure.

It should be noted that all directional indications, for example, up, down, left, right, front, back, clockwise, anticlockwise, etc. in the embodiments of the disclosure are only used for explaining relative position relationships, movement situations, or the like between the various components in a specific posture. If the specific posture changes, the directional indications change accordingly.

In addition, the terms such as "first" and "second" in the disclosure are used only for the purpose of description, and should not be understood as indicating or implying the relative importance or implicitly specifying the quantity of the indicated technical features. Therefore, a feature restricted by "first" or "second" may explicitly indicate or implicitly include at least one of such features. In addition, technical solutions of each embodiment may be combined with each other, but should be only on the basis that they can be implemented by persons of ordinary skill in the art. When there is a conflict in a combination of technical solutions or the technical solution cannot be implemented, it should be considered that such a combination of technical solutions does not exist, and it is not within the protection scope of the disclosure.

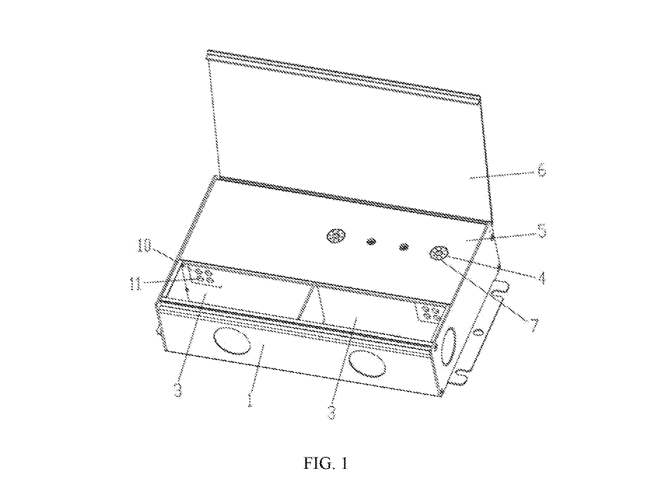

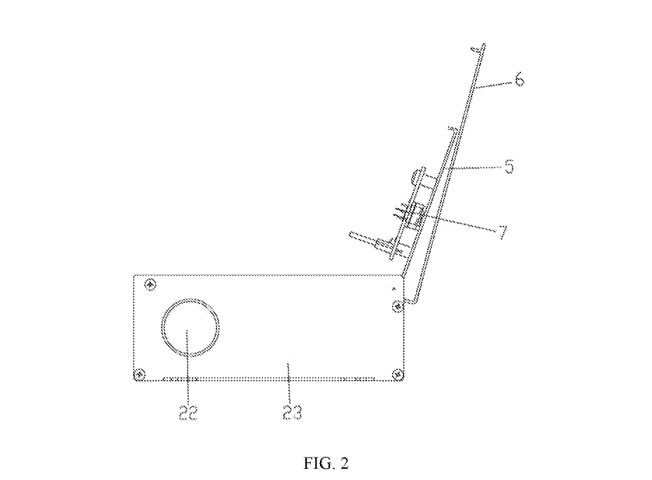

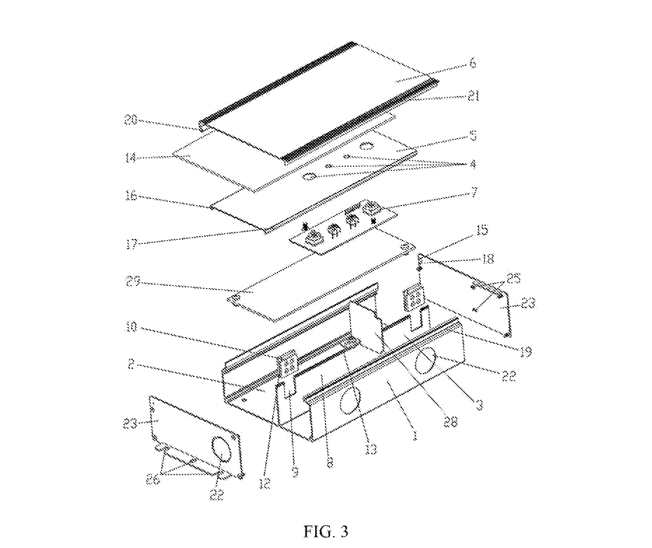

As shown in FIG. 1 to FIG. 3, in this embodiment, a power box with an electrical parameter adjusting function of the disclosure includes a box body 1, a power supply chamber 2 and wiring chambers 3 are disposed in the box body 1, an inner cover plate 5 and an outer cover plate 6 are disposed on the box body 1, the inner cover plate 5 covers the power supply chamber 2, the outer cover plate 6 covers the power supply chamber 2 and the wiring chambers 3, adjusting modules 7 positioned in the power supply chamber 2 are disposed on the inner cover plate 5, and adjusting holes 4 corresponding to the adjusting modules 7 are formed in the inner cover plate 5. The adjusting modules 7 are connected to the bottom of the inner cover plate 5 through screws. Additionally, when the inner cover plate 5 and the outer cover plate 6 are closed, the outer cover plate 6 is also covered and closed on the inner cover plate 5 at the same time.

By aiming at the defects in the prior art, the disclosure adopts the technical solution that the adjusting modules 7 are disposed on the inner cover plate 5 and are positioned in the power supply chamber 2, so the occupation on the installation space of the wiring chambers 3 may be avoided. When the adjusting module 7 is adjusted, the influence by cables in the wiring chambers 3 may be avoided. Additionally, during electrical parameter adjustment and after the outer cover plate 6 is opened, the adjusting modules 7 may be adjusted through the adjusting holes 4, so the electrical parameter adjustment is convenient, and the disclosure has the advantages of space saving and convenience in electrical parameter adjustment.

In some embodiments, a middle partition board 8 is disposed among the power supply chamber 2 and the wiring chambers 3 for partition, notches 9 are formed on the middle partition board 8, the power supply chamber 2 and the wiring chambers 3 all communicate with the notches 9, a cable protection sheath 10 is disposed on each of the notches 9, and cable passing holes 11 are formed in the cable protection sheath 10. A clamping groove 12 is formed on each cable protection sheath 10, the cable protection sheathes 10 are clamped and connected onto the corresponding notches 9 through the clamping groove 12, and cables may pass through the cable protection sheathes 10. Concretely, the cable protection sheathes 10 are clamped and connected onto the notches 9 through the clamping groove 12, so that the cable protection sheathes 10 may be conveniently installed, and cables among the power supply chamber 2 and the wiring chambers 3 may pass through the cable passing holes 11 of the cable protection sheathes 10.

In some embodiments, knocking-off holes 22 are formed in each of the wiring chambers 3. Concretely, knocking-off holes 22 are formed in the front end, the bottom and two sides of each of the wiring chambers 3. The knocking-off holes 22 are formed in each of the wiring chambers 3, and cables may pass through the knocking-off holes, so that the installation and use are convenient.

In some embodiments, side plates 23 are disposed at two sides of the box body 1, and installing holes 26 are formed in the bottom of each of the side plates 23. Threaded holes are formed at two sides of the box body 1, and screws are connected into the threaded holes, so that the side plates 23 may be connected to the side ends of the box body 1 through screw threads. A plurality of positioning blocks 25 matched with the middle partition board 8 are disposed in each of the side plates 23. Through the positioning effect of the positioning blocks 25 on the middle partition board 8, the middle partition board 8 has high stability. Additionally, when being installed, the power box is fixedly connected onto an installing surface through the installing holes 26.

In some embodiments, the quantity of the power supply chamber 2 is at least one, the quantity of the wiring chambers 3 is at least two, and the partition board(s) 28 is(are) disposed among a plurality of wiring chambers 3 for partition. A circuit board 29 is placed in the power supply chamber 2, and the circuit board 29 is electrically connected with the adjusting modules 7.

In some embodiments, a waterproof pad 14 positioned in the box body 1 is disposed on the outer cover plate 6. The outer cover plate 6 may cover the power supply chamber 2 and the wiring chambers 3 when being closed, so that a waterproof effect is achieved through the waterproof pad 14 disposed at the bottom of the outer cover plate 6.

In some embodiments, second rotary posts 18 and a second clamping position 19 are disposed on the box body 1, second rotary holes 20 are formed in one end of the outer cover plate 6, the second rotary holes 20 are rotationally connected with the second rotary posts 18, a second clamping clip 21 is disposed at the other end of the outer cover plate 6, and the second clamping clip 21 is able to be clamped and connected onto the second clamping position 19. The first rotary post 15 is positioned above the corresponding second rotary post 18, a first clamping position 13 is disposed on the middle partition board 8, the first rotary posts 15 are disposed on the box body 1, first rotary holes 16 are formed in one end of the inner cover plate 5, the first rotary holes 16 and the first rotary posts 15 are rotationally connected, the other end of the inner cover plate 5 is provided with a first clamping clip 17, and the first clamping clip 17 is able to be clamped and connected onto the first clamping position 13. Concretely, the first rotary holes 16 are rotationally connected with the first rotary posts 15, so that the inner cover plate 5 is rotatable and may be opened to a certain angle relative to the box body 1. Additionally, the first clamping clip 17 may be clamped and connected onto the first clamping position 13 when the inner cover plate 5 reversely rotates, so that the inner cover plate 5 can be tightly buckled after being closed. Identically, the second rotary holes 20 and the second rotary posts 18 are rotationally connected, so that the outer cover plate 6 is rotatable and may be opened to a certain angle relative to the box body 1, and additionally, the second clamping clip 21 may be clamped and connected onto the second clamping position 19 when the outer cover plate 6 reversely rotates, so that the outer cover plate 6 is tightly buckled after being closed.

In some embodiments, the inner cover plate 5 is connected onto the box body 1 in one connection manner of threaded connection, rotational connection or clamping connection, and the outer cover plate 6 is connected onto the box body 1 in one connection manner of threaded connection, rotational connection or clamping connection.

The above embodiments are only exemplary embodiments of the disclosure, and do not therefore limit the patent scope of the disclosure. Under the invention concept of the disclosure, the equivalent structure transformation made by using the contents of the description and drawings of the disclosure, or the direct/indirect application in other related technical fields are included in the patent protection scope of the disclosure.

What is claimed is:

1. The power box with an electrical parameter adjusting function, comprising a box body, wherein a power supply chamber and wiring chambers are disposed in the box body, an inner cover plate and an outer cover plate are disposed on the box body, the inner cover plate covers the power supply chamber, the outer cover plate covers the power supply chamber and the wiring chambers, adjusting modules positioned in the power supply chamber are disposed on the inner cover plate, and adjusting holes corresponding to the adjusting modules are formed in the inner cover plate.

2. The power box with an electrical parameter adjusting function according to claim 1, wherein a middle partition board is disposed among the power supply chamber and the wiring chambers for partition, notches are formed on the middle partition board, the power supply chamber and the wiring chambers all communicate with the notches, a cable protection sheath is disposed on each of the notches, and cable passing holes are formed in the cable protection sheath.

3. The power box with an electrical parameter adjusting function according to claim 1, wherein knocking-off holes are formed in each of the wiring chambers.

4. The power box with an electrical parameter adjusting function according to claim 1, a side plate is disposed at each of two sides of the box body, and installing holes are formed in the side plate.

5. The power box with an electrical parameter adjusting function according to claim 4, wherein the quantity of the power supply chamber is at least one, the quantity of the wiring chambers is at least two, and the partition board(s) is(are) disposed among a plurality of wiring chambers for partition.

6. The power box with an electrical parameter adjusting function according to claim 5, wherein a circuit board is placed in the power supply chamber, and the circuit board is electrically connected with the adjusting modules.

7. The power box with an electrical parameter adjusting function according to claim 1, wherein a waterproof pad positioned in the box body is disposed on the outer cover plate.

8. The power box with an electrical parameter adjusting function according to claim 1, wherein second rotary posts and a second clamping position are disposed on the box body, second rotary holes are formed in one end of the outer cover plate, the second rotary holes are rotationally connected with the second rotary posts, a second clamping clip is disposed at the other end of the outer cover plate, and the second clamping clip is able to be clamped and connected onto the second clamping position.

9. The power box with an electrical parameter adjusting function according to claim 4, wherein the inner cover plate is connected onto the box body in one connection manner of threaded connection, rotational connection or clamping connection, and the outer cover plate is connected onto the box body in one connection manner of threaded connection, rotational connection or clamping connection.

10. The power box with an electrical parameter adjusting function according to claim 8, wherein a first clamping position is disposed on the middle partition board, first rotary posts are disposed on the box body, first rotary holes are formed in one end of the inner cover plate, the first rotary holes and the first rotary posts are rotationally connected, the other end of the inner cover plate is provided with a first clamping clip, and the first clamping clip is able to be clamped and connected onto the first clamping position.
